(19) United States
(12) Patent Application Publication
(10) Pub. No.: US 2021/0142255 A1
(43) Pub. Date: May 13, 2021

(54) SYSTEM FOR AUTOMATIC IDENTIFICATION AND MAPPING OF INTERACTION ATTRIBUTES TO GENERATE CUSTOM ASSESSMENT FUNCTIONALITY

(71) Applicant: BANK OF AMERICA CORPORATION, Charlotte, NC (US)

(72) Inventors: Nipun Mahajan, Lawrenceville, NJ (US); Sanjay Deshmukh, Robbinsville, NJ (US); Yogesh Raghuvanshi, Princeton, NJ (US)

(73) Assignee: BANK OF AMERICA CORPORATION, Charlotte, NC (US)

(21) Appl. No.: 16/680,076

(22) Filed: Nov. 11, 2019

(51) Int. Cl. G06Q 10/06; G06Q 10/10

(52) U.S. Cl. CPC G06Q 10/06393; G06Q 10/10; G06Q 10/06395

(57) ABSTRACT

Embodiments of the present invention provide a system for automatically identifying and mapping interaction attributes to generate custom assessment functionality. The system is configured for identifying one or more interaction channels associated with an entity, gathering flow sets associated with the one or more interaction channels, identifying one or more segments associated with the one or more interaction channels based on the flow sets, mapping one or more attributes with the one or more segments, and generating an assessment functionality based on mapping the one or more attributes with the one or more segments.

### BACKGROUND

Conventional systems do not have the capability to dynamically generate real-time custom assessment functionalities. As such, there exists a need for a system to generate custom assessment functionalities in real-time based on incoming real-time interaction data.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for automatically identifying and mapping interaction attributes to generate custom assessment functionality. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention identifies one or more interaction channels associated with an entity, gathers flow sets associated with the one or more interaction channels, identifies one or more segments associated with the one or more interaction channels based on the flow sets, maps one or more attributes with the one or more segments, and generates an assessment functionality based on mapping the one or more attributes with the one or more segments.

In some embodiments, the present invention identifies the one or more segments associated with the one or more interaction channels based on scanning the flow sets.

In some embodiments, the present invention identifies the one or more segments associated with the one or more interaction channels based on scanning the flow sets.

In some embodiments, the present invention generates the assessment functionality based on generating one or more questions associated with each of the one or more segments; and mapping the one or more attributes with the one or more questions.

In some embodiments, the present invention establishes a communication link with the one or more interaction channels and continuously monitors the one or more interaction channels.

In some embodiments, the present invention identifies initiation of a real-time interaction associated with at least one interaction channel based on monitoring the one or more interaction channels, in response to identifying the initiation of the real-time interaction, gathers real-time interaction data from the one or more interaction channels, processes the real-time interaction data associated with the real-time interaction, and generates a real-time assessment functionality by dynamically generating a real-time questionnaire based on processing the real-time interaction data.

In some embodiments, the present invention processes the real-time interaction data by identifying one or more phrases associated with the real-time interaction and mapping the one or more phrases with the one or more attributes. In some embodiments, the present invention presents the real-time questionnaire to a user associated with the real-time interaction via the at least one interaction channel.

In some embodiments, the one or more interaction channels are audio interaction channels.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for automatically identifying and mapping interaction attributes to generate custom assessment functionality, in accordance with an embodiment of the invention;

FIG. 2 provides a block diagram illustrating the entity system 200 of FIG. 1, in accordance with an embodiment of the invention;

FIG. 3 provides a block diagram illustrating an assessment functionality generation system 300 of FIG. 1, in accordance with an embodiment of the invention;

FIG. 4 provides a block diagram illustrating the computing device system 400 of FIG. 1, in accordance with an embodiment of the invention;

FIG. 5 provides a flowchart illustrating a process flow for automatically identifying and mapping interaction attributes to define segment definitions, in accordance with an embodiment of the invention; and

FIG. 6 provides a flowchart illustrating a process flow for dynamically generating a real-time assessment functionality based on the segment definition, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “entity” may include any organization that processes financial transactions including, but not limited to, banks, credit unions, savings and loan associations, investment companies, stock brokerages, asset management firms, insurance companies and the like. In accordance with embodiments of the invention, the terms “third party system” and “other third party systems” may include any organization that processes financial transactions including, but not limited to, banks, credit unions, savings and loan associations, investment companies, stock brokerages, asset management firms, insurance companies and the like. Furthermore, embodiments of the present invention use the term “user” or “customer.” It will be appreciated by someone with ordinary skill in the art that the user or customer may be a customer of the financial institution or a potential customer of the financial institution.

In accordance with embodiments of the invention, a “resource pool” or an “account” is the relationship that a customer has with an entity, such as a financial institution. Examples of accounts include a deposit account, such as a transactional account (e.g., a banking account), a savings account, an investment account, a money market account, a time deposit, a demand deposit, a pre-paid account, a credit account, a debit/deposit account, a non-monetary user profile that includes information associated with the user, or the like. The account is associated with and/or maintained by the entity.

In accordance with embodiments of the invention, an “interaction channel” may be any kind of communication channel that allows a user of the entity to interact with one or more interaction systems that are associated with the entity. In some embodiments, the interaction channel may be an audio interaction channel. Although the invention presented herein is described with respect to audio interaction channels, the process flow associated with the system of the present invention may be applied to other interaction channels.

In accordance with embodiments of the invention, an “interaction” may be any kind of interaction including but not limited to resource interaction, any operation associated with the resource pool of the user, request for assistance associated with technical and/or non-technical issues, placing orders, or the like. In accordance with embodiments of the invention, a “resource interaction” may be a transaction, transfer of funds, transfer of resources between two users, a user and an entity, a user and a third party entity, and/or entity and a third party system. Transfer of resources may refer to a payment, processing of funds, international transfer of funds, purchase of goods or services, a return of goods or services, a payment transaction, a credit transaction, or other interactions involving user's resource or account.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

FIG. 1 provides a block diagram illustrating a system environment 100 for automatically identifying and mapping interaction attributes to generate custom assessment functionality, in accordance with an embodiment of the invention. As illustrated in FIG. 1, the environment 100 includes an assessment functionality generation system 300, entity system 200, a computing device system 400, and one or more interaction systems 201. One or more users 110 may be included in the system environment 100, where the users 110 interact with the other entities of the system environment 100 via a user interface of the computing device system 400. In some embodiments, the one or more user(s) 110 of the system environment 100 may be customers of an entity associated with the entity system 200.

The entity system(s) 200 may be any system owned or otherwise controlled by an entity to support or perform one or more process steps described herein. In some embodiments, the managing entity is a financial institution. In some embodiments, the managing entity is a non-financial institution. In some embodiments, the managing entity is any institution that interacts with customers to perform one or more operations for the customers.

The one or more interaction systems 201 may be any systems that facilitate user interactions. In some embodiments, the one or more interaction systems 201 may be a part of the entity system 200. In some embodiments, the one or more interaction systems 201 may be audio interaction systems.

The assessment functionality generation system 300 is a system of the present invention for performing one or more process steps described herein. In some embodiments, the assessment functionality generation system 300 may be an independent system. In some embodiments, the assessment functionality generation system 300 may be a part of the entity system 200.

The assessment functionality generation system 300, the entity system 200, the computing device system 400, and/or the one or more interaction systems 201 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the assessment functionality generation system 300 is configured to communicate information or instructions with the entity system 200, the computing device system 400, and/or the one or more interaction systems 201 across the network 150.

The computing device system 400 may be a system owned or controlled by the entity of the entity system 200, the user 110, and/or a third party. As such, the computing device system 400 may be a computing device of the user 110. In general, the computing device system 400 communicates with the user 110 via a user interface of the computing device system 400, and in turn is configured to communicate information or instructions with the assessment functionality generation system 300, entity system 200, and/or the one or more interaction systems 201 across the network 150.

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, an assessment functionality generation application 250, one or more entity application 270, an interaction application 260, and a data repository 280 comprising interaction data 283 and user preference data (not shown). The computer-executable program code of the network server application 240, the assessment functionality generation application 250, the one or more entity application 270, the interaction application 260 to perform certain logic, data-extraction, and data-storing functions of the entity system 200 described herein, as well as communication functions of the entity system 200.

The network server application 240, the assessment functionality generation application 250, the one or more entity application 270, the interaction application 260 are configured to store data in the data repository 280 or to use the data stored in the data repository 280 when communicating through the network communication interface 210 with the assessment functionality generation system 300, the computing device system 400, and/or the one or more interaction systems 201 to perform one or more process steps described herein. In some embodiments, the entity system 200 may receive instructions from the assessment functionality generation system 300 via the assessment functionality generation application 250 to perform certain operations. The assessment functionality generation application 250 may be provided by the assessment functionality generation system 300. The one or more entity applications 270 may be any of the applications used, created, modified, and/or managed by the entity system 200. The interaction application 260 is an application that is used by the entity system 200 to communicate with the interaction system 201 and/or the users of the entity.

FIG. 3 provides a block diagram illustrating the assessment functionality generation system 300 in greater detail, in accordance with embodiments of the invention. As illustrated in FIG. 3, in one embodiment of the invention, the assessment functionality generation system 300 includes one or more processing devices 320 operatively coupled to a network communication interface 310 and a memory device 330. In certain embodiments, the assessment functionality generation system 300 is operated by a first entity, such as a financial institution, while in other embodiments, the assessment functionality generation system 300 is operated by an entity other than a financial institution. In some embodiments, the assessment functionality generation system 300 is owned or operated by the entity of the entity system 200. In some embodiments, the assessment functionality generation system 300 may be an independent system. In alternate embodiments, the assessment functionality generation system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the assessment functionality generation system 300 described herein. For example, in one embodiment of the assessment functionality generation system 300, the memory device 330 includes, but is not limited to, a network provisioning application 340 a segment identification application 350, an attribute mapping application 360, an assessment generation application 370, and a data repository 390 comprising data processed or accessed by one or more applications in the memory device 330. The computer-executable program code of the network provisioning application 340, the segment identification application 350, the attribute mapping application 360, and the assessment generation application 370, may instruct the processing device 320 to perform certain logic, data-processing, and data-storing functions of the assessment functionality generation system 300 described herein, as well as communication functions of the assessment functionality generation system 300.

The network provisioning application 340, the segment identification application 350, the attribute mapping application 360, and the assessment generation application 370 are configured to invoke or use the data in the data repository 390 when communicating through the network communication interface 310 with the entity system 200, the computing device system 400, and/or the one or more interaction systems 201. In some embodiments, the network provisioning application 340, the segment identification application 350, the attribute mapping application 360, and the assessment generation application 370 may store the data extracted or received from the entity system 200, the third party system 201, and the computing device system 400 in the data repository 390. In some embodiments, the network provisioning application 340, the segment identification application 350, the attribute mapping application 360, and the assessment generation application 370 may be a part of a single application.

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, an assessment functionality generation application 421, entity application 424. These applications also typically instructions to a graphical user interface (GUI) on the display 430 that allows the user 110 to interact with the entity system 200, the assessment functionality generation system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the assessment functionality generation application 421 provided by the assessment functionality generation system 300 allows the user 110 to access the assessment functionality generation system 300. In some embodiments, the entity application 424 provided by the entity system 200 and the assessment functionality generation application 421 allow the user 110 to access the functionalities provided by the assessment functionality generation system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

FIG. 5 provides a flowchart illustrating a process flow 500 for automatically identifying and mapping interaction attributes to define segment definitions, in accordance with an embodiment of the invention. As shown in block 510, the system identifies one or more interaction channels associated with an entity. In some embodiments, the system may identify the one or more interaction channels based on user input. In some embodiments, the system may perform a scan to identify the one or more interaction channels. In some embodiments, the one or more interaction channels may be audio interaction channels. In such embodiments, each of the one or more interaction channels may associated with a unique functionality. For example, a first interaction channel may be associated with performing resource interactions. In another example, a second interaction channel may be associated with resolving technical issues.

As shown in block 520, the system gathers flow sets associated with the one or more interaction channels. The flow sets may be UI flows, mock ups, visual representations of an interaction flow. In some embodiments, one or more employees of an entity while setting up the interaction systems and interaction channels may create a specific flow sets that represent the requirements associated with each of the one or more interaction channels. The flow sets may be stored in a repository of the entity system 200 and the system retrieves the flow-sets of the one or more interaction channels.

As shown in block 530, the system scans the flow sets. As shown in block 540, the system identifies one or more segments associated with the one or more interaction channels based on the flow sets. The system scans the flow sets to identify segments associated with the flow sets. The one or more segments are segments of interaction that define the interaction flow. For example, the one or more segments may include, but are not limited to, a welcome segment, a language selection segment, an authentication segment, an intent identification segment, a multi-step function segment, a one-step function segment, and the like. Each of the one or more segment is associated with an action taken by a user that is associated with the interaction.

As shown in block 550, the system maps one or more attributes with the one or more segments. The system identifies one or more attributes associated with each of the one or more segments and maps the one or more attributes with the one or more segments. In some embodiments, the system may identify the one or more attributes based on an input from an employee of the entity. The one or more attributes define parameters associated with a segment based on which assessment functionalities are generated. For example, for an authentication segment the one or more attributes may include, but are not limited to, prompt duration, time taken, number of attempts, result, confirmation, input type, and the like. In an exemplary embodiment, the system may generate an assessment functionality in real-time based on the time taken attribute associated with the authentication segment. The time taken attribute value may define the initiation of the assessment functionality. For example, if the time taken by a user to complete the authentication segment is more than a predefined limit, the system dynamically initiates an assessment questionnaire in real-time to receive feedback from the user. In some embodiments, the predefined values that are associated with the one or more attributes are specific to a user.

As shown in block 560, the system generates one or more questions associated with each of the one or more segments. For each attribute associated with each of the one or more segments, the system automatically generates a question that is associated with getting feedback from a user that is specific to a particular attribute of a particular section. Continuing with the previous example, the system may generate a question associated with the unusual time take taken to complete the authentication step. As shown in block 570, the system maps the one or more attributes with the one or more questions. The system then stores the one or more questions in a data repository. The system may sort the questions based on segments and attributes to quickly access the one or more questions in real-time.

FIG. 6 provides a flowchart illustrating a process flow 600 for dynamically generating a real-time assessment functionality based on the segment definition, in accordance with an embodiment of the invention. As shown in block 610, the system establishes a communication link with the one or more interaction channels. As shown in block 620, the system continuously monitors the one or more interaction channels.

As shown in block 630, the system identifies initiation of a real-time interaction associated with at least one interaction channel based on monitoring the one or more interaction channels. For example, the system may identify initiation of a real-time interaction based on identifying that an interaction system received an audio call from a user.

As shown in block 640, the system in response to identifying initiation of the real-time interaction, gathers real-time interaction data from the one or more interaction channels. Continuing with the previous example, the system may gather the real-time audio conversation associated with the audio call.

As shown in block 650, the system processes the real-time interaction data associated with the real-time interaction. The system may convert the speech in the real-time audio conversation instantly to text and then processes the text. In some embodiments, the system identifies one or more phrases from the text and automatically maps the one or more phrases with the one or more attributes of the one or more segments.

As shown in block 660, the system dynamically generates a real-time questionnaire based on processing the real-time interaction data. The system generates the questionnaire if the current values of the one or more attributes are greater than the predefined values of the one or more attributes. Based on mapping the one or more phrases with the one or more attributes, the system extracts the one or more questions that are associated with the attributes that are associated with the identified phrases and generates the real-time questionnaire. For example, the system may identify a pin number received from the user and may automatically identify that the pin number is associated with the authentication segment. The system may associate the pin number with number of attempts attribute of the authentication segment. In an exemplary embodiment, where the user inputs the pin number more than three times and the system may identify that the number of attempts attribute is greater than a predefined value (e.g., two attempts) and may extract the question associated with the number of attempts attribute to generate a real-time questionnaire.

In some embodiments, the generation of the real-time questionnaire is based on user preferences and is custom to a specific user. For example, if the time taken attribute value associated with authentication segment is more than a predefined value, the system accesses the historical audio call data and user preference data to identify that the time taken attribute value is typical for a type of authentication that the user uses for the authentication process and it does not generate a questionnaire associated with the time taken attribute.

As shown in block 670, the system presents the real-time questionnaire to a user associated with the real-time interaction via the at least one interaction channel.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for automatically identifying and mapping interaction attributes to generate custom assessment functionality, the system comprising:
at least one network communication interface;
at least one non-transitory storage device; and
at least one processing device coupled to the at least one non-transitory storage device and the at least one network communication interface, wherein the at least one processing device is configured to:
identify one or more interaction channels associated with an entity;
gather flow sets associated with the one or more interaction channels;
identify one or more segments associated with the one or more interaction channels based on the flow sets;
map one or more attributes with the one or more segments; and
generate an assessment functionality based on mapping the one or more attributes with the one or more segments.

2. The system of claim 1, wherein the at least one processing device is configured to identify the one or more segments associated with the one or more interaction channels based on scanning the flow sets.

3. The system of claim 1, wherein the at least one processing device is configured to generate the assessment functionality based on:
generating one or more questions associated with each of the one or more segments; and
mapping the one or more attributes with the one or more questions.

4. The system of claim 1, wherein the at least one processing device is further configured to:
establish a communication link with the one or more interaction channels; and
continuously monitor the one or more interaction channels.

5. The system of claim 4, wherein the at least one processing device is further configured to:
identify initiation of a real-time interaction associated with at least one interaction channel based on monitoring the one or more interaction channels;
in response to identifying the initiation of the real-time interaction, gather real-time interaction data from the one or more interaction channels;
process the real-time interaction data associated with the real-time interaction; and
generate a real-time assessment functionality by dynamically generating a real-time questionnaire based on processing the real-time interaction data.

6. The system of claim 5, wherein processing the real-time interaction data comprises:
identifying one or more phrases associated with the real-time interaction; and
mapping the one or more phrases with the one or more attributes.

7. The system of claim 6, wherein the at least one processing device is further configured to:
present the real-time questionnaire to a user associated with the real-time interaction via the at least one interaction channel.

8. The system of claim 1, wherein the one or more interaction channels are audio interaction channels.

9. A computer program product for automatically identifying and mapping interaction attributes to generate custom assessment functionality, the computer program product comprising a non-transitory computer-readable storage medium having computer executable instructions for causing a computer processor to perform the steps of:
identifying one or more interaction channels associated with an entity;
gathering flow sets associated with the one or more interaction channels;
identifying one or more segments associated with the one or more interaction channels based on the flow sets;
mapping one or more attributes with the one or more segments; and
generating an assessment functionality based on mapping the one or more attributes with the one or more segments.

10. The computer program product of claim 9, wherein identifying the one or more segments associated with the one or more interaction channels is based on scanning the flow sets.

11. The computer program product of claim 9, wherein generating the assessment functionality comprises:
generating one or more questions associated with each of the one or more segments; and
mapping the one or more attributes with the one or more questions.

12. The computer program product of claim 9, wherein the computer executable instructions cause the computer processor to:
establish a communication link with the one or more interaction channels;
continuously monitor the one or more interaction channels;
identify initiation of a real-time interaction associated with at least one interaction channel based on monitoring the one or more interaction channels;
in response to identifying the initiation of the real-time interaction, gather real-time interaction data from the one or more interaction channels;
process the real-time interaction data associated with the real-time interaction; and
generate a real-time assessment functionality by dynamically generating a real-time questionnaire based on processing the real-time interaction data.

13. The computer program product of claim 12, wherein processing the real-time interaction data comprises:
identifying one or more phrases associated with the real-time interaction; and
mapping the one or more phrases with the one or more attributes.

14. The computer program product of claim 13, the computer executable instructions cause the computer processor to present the real-time questionnaire to a user associated with the real-time interaction via the at least one interaction channel.

15. A computer implemented method for automatically identifying and mapping interaction attributes to generate custom assessment functionality, the method comprising:
identifying one or more interaction channels associated with an entity;
gathering flow sets associated with the one or more interaction channels;
identifying one or more segments associated with the one or more interaction channels based on the flow sets;
mapping one or more attributes with the one or more segments; and
generating an assessment functionality based on mapping the one or more attributes with the one or more segments.

16. The computer implemented method of claim 15, wherein identifying the one or more segments associated with the one or more interaction channels is based on scanning the flow sets.

17. The computer implemented method of claim 15, wherein generating the assessment functionality comprises:
generating one or more questions associated with each of the one or more segments; and
mapping the one or more attributes with the one or more questions.

18. The computer implemented method of claim 17, wherein the method further comprises:
establishing a communication link with the one or more interaction channels;
continuously monitoring the one or more interaction channels;
identifying initiation of a real-time interaction associated with at least one interaction channel based on monitoring the one or more interaction channels;
in response to identifying the initiation of the real-time interaction, gathering real-time interaction data from the one or more interaction channels;
processing the real-time interaction data associated with the real-time interaction; and
generating a real-time assessment functionality by dynamically generating a real-time questionnaire based on processing the real-time interaction data.

19. The computer implemented method of claim 18, wherein processing the real-time interaction data comprises:
identifying one or more phrases associated with the real-time interaction; and
mapping the one or more phrases with the one or more attributes.

20. The computer implemented method of claim 18, wherein the method further comprises presenting the real-time questionnaire to a user associated with the real-time interaction via the at least one interaction channel.
